(19) United States
(12) Patent Application Publication
(10) Pub. No.: US 2025/0141786 A1
(43) Pub. Date: May 1, 2025

(54) POWER GRID ACCESS SECURITY SYSTEM AND METHOD FOR INTERMITTENT COMMUNICATION PORTS

(71) Applicant: Electronics and Telecommunications Research Institute, Daejeon (KR)

(72) Inventors: Giha YOON, Daejeon (KR); HARK YOO, Daejeon (KR); GEUN YONG KIM, Daejeon (KR); Sung Chang Kim, Daejeon (KR); Chorwon Kim, Daejeon (KR)

(73) Assignee: Electronics and Telecommunications Research Institute, Daejeon (KR)

(21) Appl. No.: 18/781,498

(22) Filed: Jul. 23, 2024

(30) Foreign Application Priority Data
Oct. 31, 2023 (KR) 10-2023-0148311
Jan. 25, 2024 (KR) 10-2024-0011715

(51) Int. Cl. H04L 45/24; H04L 9/40; H04L 41/0816

(52) U.S. Cl. CPC H04L 45/245; H04L 41/0816; H04L 63/0428

(57) ABSTRACT

A power grid access security system for intermittent communication ports includes a link manager configured to manage and monitor a link of a communication port, a power source configured to supply needed for a function operation of the communication port, and a multi-interface configured to integrate and provide an interface for a network link and a security service, wherein the link manager checks whether a network link of an external device is established, based on link setting information, and when a condition for the network link is not satisfied, removes data received from the external device, based on the link setting information.

### CROSS-REFERENCE TO RELATED APPLICATIONS

This application claims the benefit of the Korean Patent Application Nos. 10-2023-0148311 filed on Oct. 31, 2023, and 10-2024-0011715 filed on Jan. 25, 2024, which are hereby incorporated by reference as if fully set forth herein.

### BACKGROUND

### Field of the Invention

The present invention relates to a power grid access security system and method for intermittent communication ports.

### Discussion of the Related Art

FIG. 1 is a diagram for describing an industrial network (an open network) 100 (110 and 120) of the related art where information technology (IT) and operational technology (OT) are provided.

In the open network 100, security enhancement is needed for an open portion of a network, and to this end, a firewall device has been introduced in the Internet network and a link part of its network. The firewall device has been designed to effectively cope with a malicious code attack and abnormal external access based on a known method from the outside, based on various security policies. To maintain a security method, the maintenance of firewall devices is needed.

FIG. 2 is a diagram for describing an example of a cyber threat of an industrial network 200 of power field.

The industrial network 200 having a closed-network configuration illustrated in FIG. 2 has a closed characteristic where a link with the outside is limited. However, in such a closed network, an access of an engineering personal computer (PC) or a link of a storage device may be needed in terms of industrial equipment management such as the maintenance and upgrade of devices.

Due to such a physical access, the cyber threat may occur. Particularly, the infection of a malicious code such as malware or virus may occur through an access of an engineering PC or a link of a storage device.

FIG. 3 is a diagram for describing an access structure of network relay equipment 310 of the related art.

FIG. 3 illustrates a general chip unit structure of the network relay equipment 310 of the related art. In such a configuration, when medial dependent interface (MDI) standards of an IT device and an OT device 320 are the same, a physical link is possible, and in network protocol allowed in the network relay equipment 310, a network access between the IT device and the OT device 320 linked to each other is possible.

However, in this case, cyber threat such as the occurrence of a communication problem or the distribution of a malicious code may occur due to a network access of an unauthorized user through the vulnerability of accessible network protocol.

### PRIOR ART REFERENCE

### [Patent Document]

Korean Patent Registration No. 10-1662118 (2016.10.05)

### SUMMARY

An aspect of the present invention is directed to providing a power grid access security system and method for intermittent communication ports, which may cope with a physical threat and a logical threat capable of occurring under a situation where OT protocol and IT protocol are simultaneously managed in a public network or an open network, due to an increase in introduction of an Internet of things (IoT) device in various kinds of industrial fields.

The objects of the present invention are not limited to the aforesaid, but other objects not described herein will be clearly understood by those skilled in the art from descriptions below.

To achieve these and other advantages and in accordance with the purpose of the invention, as embodied and broadly described herein, there is provided a power grid access security system for intermittent communication ports, the power grid access security system including: a link manager configured to manage and monitor a link of a communication port; a power source configured to supply needed for a function operation of the communication port; and a multi-interface configured to integrate and provide an interface for a network link and a security service, wherein the link manager checks whether a network link of an external device is established, based on link setting information, and when a condition for the network link is not satisfied, removes data received from the external device, based on the link setting information.

In some embodiments of the present invention, the multi-interface may obtain information of the external device including at least one of identification information, an access allowance time, a link method, whether encryption is used or not, and an encryption key for the external device, and the link manager may change the link setting information, based on the information of the external device.

In some embodiments of the present invention, when the link setting information is satisfied, the link manager may allow the network link of the external device and when an event including at least one of a disallowed communication protocol sensing event, a link release event, and a link time elapse event of the network-linked external device is sensed, the link manager may report the event to the management device.

In some embodiments of the present invention, the power grid access security system may further include an encryption unit configured to perform packet encryption and decryption on data transmitted or received to or from the network-linked external device.

In some embodiments of the present invention, the power grid access security system may be implemented as a module type which is inserted into a communication port of network relay equipment.

In some embodiments of the present invention, the power grid access security system may be implemented by printed circuit board (PCB) units of network relay equipment, or is implemented to be embedded in a network relay chipset as a system on chip (SoC) or system on package (SoP) type.

In another aspect of the present invention, there is provided a power grid access security method for intermittent communication ports, performed by a power grid access security system for intermittent communication ports, the power grid access security method including: as power is applied, maintaining a network link disconnection state; as a configuration of link setting information for the network link is completed, operating in an interface standby state; as an attempt to establish a network link of an external device is sensed, determining whether to allow a network link, based on the link setting information; and when the link setting information is not satisfied, removing data received from the external device.

In some embodiments of the present invention, the operating in the interface standby state may include: obtaining information of the external device including at least one of identification information, an access allowance time, a link method, whether encryption is used or not, and an encryption key for the external device; and changing the link setting information, based on the information of the external device.

In some embodiments of the present invention, the power grid access security method may further include: when the link setting information is satisfied, allowing the network link of the external device; and when an event including at least one of a disallowed communication protocol sensing event, a link release event, and a link time elapse event of the network-linked external device is sensed, reporting the event to a management device.

In some embodiments of the present invention, the power grid access security method may further include performing packet encryption and decryption on data transmitted or received to or from the network-linked external device.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a diagram for describing an industrial network (an open network) of the related art where information technology (IT) and operational technology (OT) are provided.

FIG. 2 is a diagram for describing an example of a cyber threat of an industrial network of power field.

FIG. 3 is a diagram for describing an access structure of network relay equipment of the related art.

FIG. 4 is a block diagram of a power grid access security system according to an embodiment of the present invention.

FIG. 5A and FIG. 5B are diagrams for describing an implementation embodiment of a power grid access security system according to an embodiment of the present invention.

FIG. 6 is a diagram for describing an embodiment implemented in a module-type structure based on a communication port unit.

FIG. 7 is a diagram for describing an embodiment which simultaneously uses an encryption module.

FIG. 8 is a flowchart of a power grid access security system according to an embodiment of the present invention.

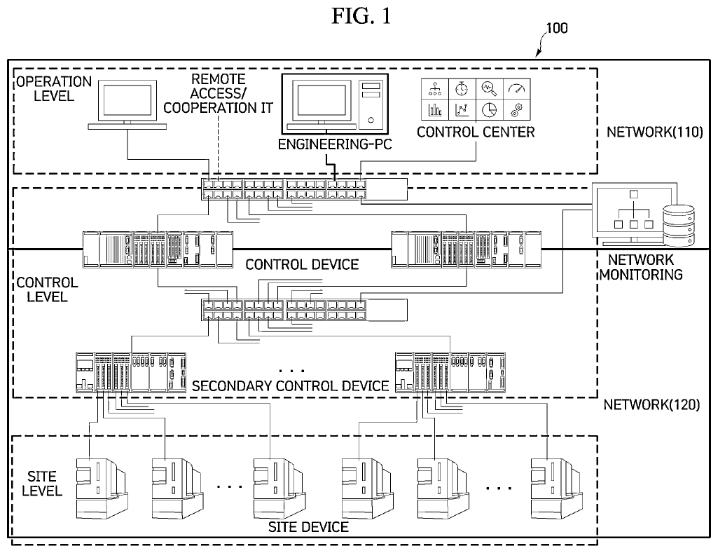

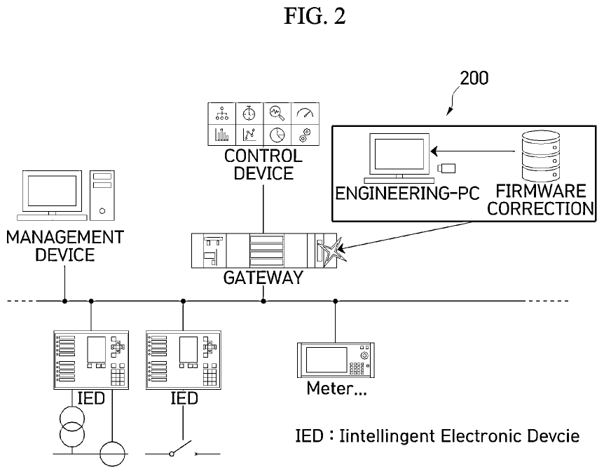

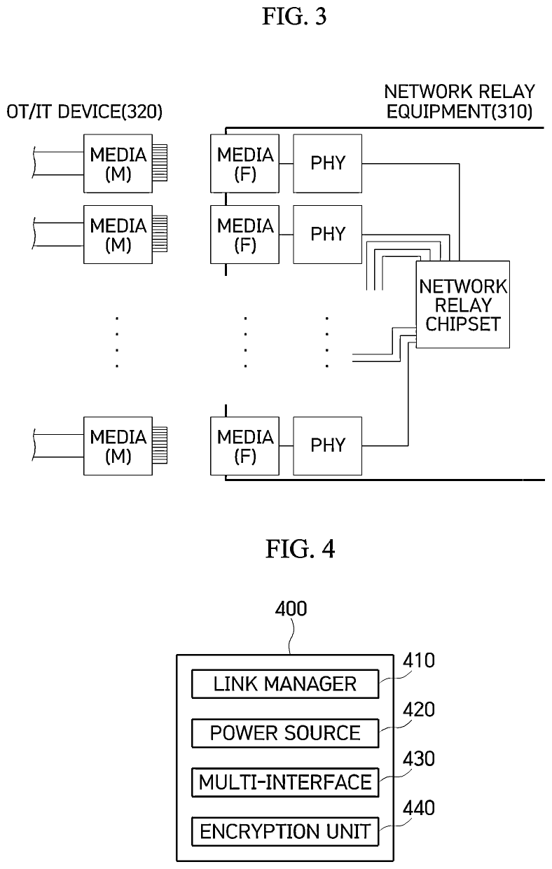

### DETAILED DESCRIPTION OF THE INVENTION

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Herein, like reference numeral refers to like element, and “and/or” include(s) one or more combinations and each of described elements. Although “first” and “second” are used for describing various elements, but the elements are not limited by the terms. Such terms are used for distinguishing one element from another element. Therefore, a first element described below may be a second element within the technical scope of the present invention.

Unless otherwise defined, all terms (including technical and scientific terms) used herein may be used as a meaning capable of being commonly understood by one of ordinary skill in the art. Also, terms defined in dictionaries used generally are not ideally or excessively construed unless clearly and specially defined.

The present invention relates to a power grid access security system and method for intermittent communication ports.

An embodiment of the present invention may be for enhancing an access security and management function on a communication port (terminal) in an open network environment used in the industrial field, and particularly, may assign a strict link limitation and effective management function on a network communication port intermittently used for maintenance of each device, thereby increasing the security of a network.

That is, an embodiment of the present invention may strictly limit an access to a communication port which is intermittently used. Accordingly, an embodiment of the present invention may prevent an unauthorized access from the outside, may minimize a potential security threat through a corresponding communication port, and may reinforce a security procedure on an access for a maintenance operation of each device.

Moreover, an embodiment of the present invention may provide detailed control and monitoring on a communication port which is intermittently used.

Accordingly, an embodiment of the present invention may thoroughly manage identification information, access authority, a link method, and an encryption setting of a device linked through a corresponding communication port, thereby maintaining the transparency and stability of a network.

As described above, an embodiment of the present invention may enhance the security of a communication port intermittently used in an open network environment and may provide an effective access and management function for safely performing a maintenance operation on the communication port, thereby enhancing the network security of the industrial field.

Hereinafter, a power grid access security system for intermittent communication ports (hereinafter referred to as a power grid access security system) according to an embodiment of the present invention will be described with reference to FIGS. 4 to 7.

FIG. 4 is a block diagram of a power grid access security system 400 according to an embodiment of the present invention.

The power grid access security system 400 according to an embodiment of the present invention may include a link manager 410, a power source (PWR) 420, a multi-interface (MI) 430, and an encryption unit 440.

The link manager 410 may manage and monitor a link of a communication port. That is, the link manager 410 may perform the setting, maintenance, and release of a link on a corresponding communication port.

The power source 420 may be an element which supplies power and may supply power needed for a function operation of the communication port.

The MI 430 may integrate and provide an interface for a network link and a security service.

In an embodiment, the MI 430 may obtain information of an external device including at least one of identification information, an access allowance time, a link method, whether encryption is used or not, and an encryption key for the external device.

Therefore, the link manager 410 may change link setting information, based on information of a link-allowed external device from a security service management server or an edge computing device.

Moreover, the link manager may check whether a network link of the external device is established, based on the link setting information. Also, when a condition for the network link is not satisfied, the link manager 410 may remove data and a packet received from the external device, based on the link setting information.

On the other hand, when the link setting information is satisfied, the link manager 410 may allow the network link of the external device. Also, when an event including at least one of a disallowed communication protocol sensing event, a link release event, and a link time elapse event of a network-linked external device is sensed subsequently, the link manager 410 may report the event to a management device (the security service management server or the edge computing device). Also, when a link event or an access of an external device which does not satisfy the link setting information is sensed, the link manager 410 may report a corresponding event to the management device.

In an embodiment, the encryption unit 440 may perform packet encryption and decryption on data transmitted or received to or from the network-linked external device. That is, the encryption unit 440 may perform packet encryption and decryption determined in a security service, so as to limit an arbitrary link by an unauthorized user. The encryption unit 440 may be applied by implementing a specially designed encryption algorithm or a block encryption-based encryption algorithm known to those skilled in the art.

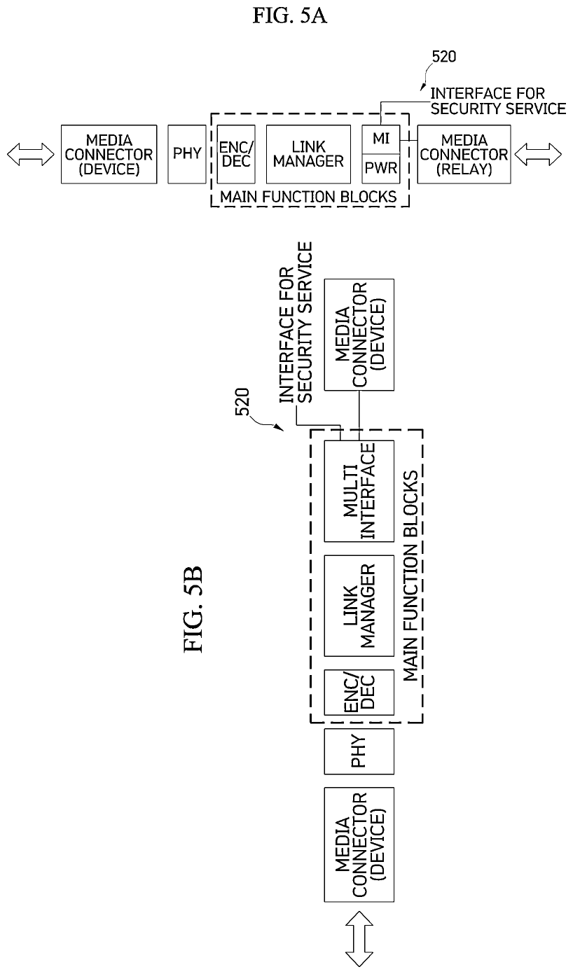

FIGS. 5A and 5B are diagrams for describing an implementation embodiment of a power grid access security system 510 and 520 according to an embodiment of the present invention.

In an embodiment, the power grid access security system 510 according to an embodiment of the present invention may be implemented as a module type which is inserted into a communication port of network relay equipment as in FIG. 5A. That is, because the power grid access security system 510 is implemented as a module type which is inserted into a communication port of network relay equipment of the related art as in FIG. 5A, the modularization and enlarged flexibility of communication equipment may be provided. Comparing with equipment of the related art, because an integration link is easily possible, a conventional network infrastructure may be easily upgraded or improved. Also, the power grid access security system 510 may be replaced with a function block capable of using corresponding power when supplying power along with a specific communication port, efficiency may increase in terms of power management.

In another embodiment, the power grid access security system 520 according to an embodiment of the present invention may be implemented by printed circuit board (PCB) units of network relay equipment as in FIG. 5B, or may be implemented to be embedded in a network relay chipset as a system on chip (SoC) or system on package (SoP) type. Based on such a structure, an embodiment of the present invention may increase the degree of integration to maximize performance and efficiency.

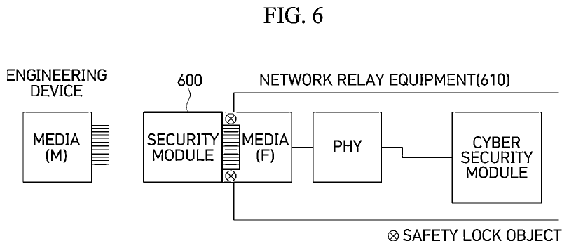

FIG. 6 is a diagram for describing an embodiment implemented in a module-type structure 600 based on a communication port unit.

A security module implemented in the module-type structure 600 based on a communication port unit according to an embodiment of the present invention may provide stronger security. The module may enhance security by applying a structure (i.e., a safety lock object) which is tightly fixed to a communication port.

The module 600 may be safely fixed to a communication port, and thus, when there is an attempt to forcibly attach/detach the security module 600, an arbitrary device or equipment linked to a communication port of network relay equipment 610 may damage the safety lock object. Accordingly, when there is an attempt to forcibly attach/detach the security module 600, a network link of an unauthorized user may be prevented, and the integrity of a system may be maintained.

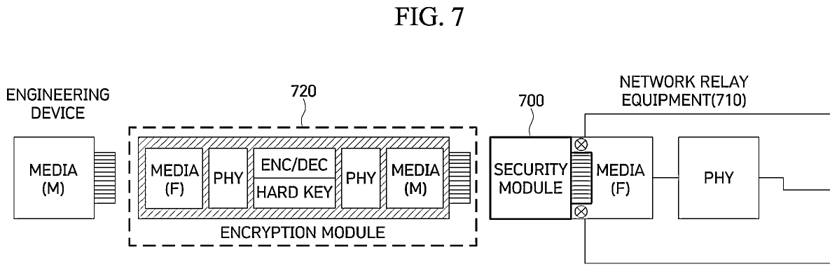

FIG. 7 is a diagram for describing an embodiment which simultaneously uses an encryption module 720.

As in FIG. 7, when a security module 710 and an encryption module 720 are simultaneously used, an encryption operation may be applied a communication port of network relay equipment 710. Therefore, a network link and access based on a general communication link device may be impossible, and thus, link management may be more strictly performed. The encryption module 720 may safely encrypt and decrypt data, and thus, may protect sensitive information and may more enhance the security and integrity of a network.

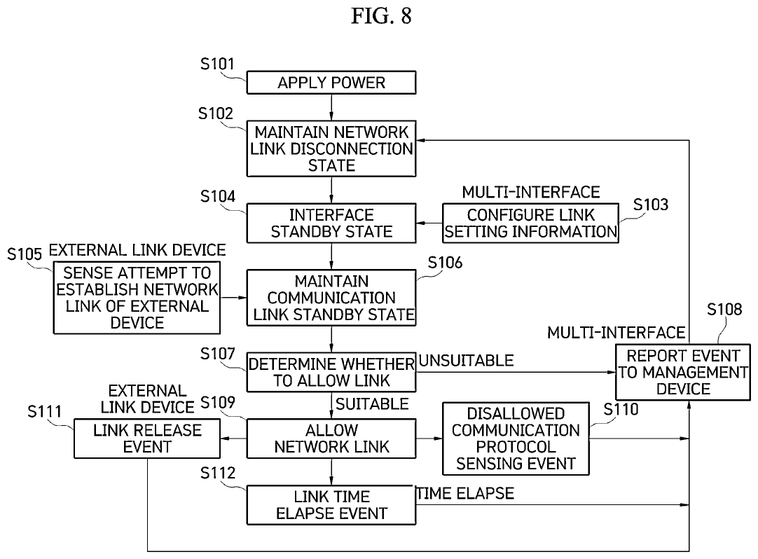

FIG. 8 is a flowchart of a power grid access security system according to an embodiment of the present invention.

First, as power is applied in step S101, the power grid access security system may maintain a network link disconnection state in step S102.

Subsequently, as a configuration of link setting information for a network link is completed in step S103, the power grid access security system may operate in an interface standby state in step S104. At this time, an embodiment of the present invention may obtain information of an external device including at least one of identification information, an access allowance time, a link method, whether encryption is used or not, and an encryption key for the external device and may change link setting information, based on information about the external device.

Subsequently, as an attempt to establish a network link of the external device is sensed in step S105, a communication link standby state may be maintained in step S106, and whether to allow a network link may be determined based on the link setting information in step S107.

When the link setting information is not satisfied as a result of the determination, the power grid access security system may remove data received from the external device and may report a corresponding event to a management device in step S108.

On the other hand, when the link setting information is satisfied as a result of the determination, the power grid access security system may allow the network link of the external device in step S109.

Subsequently, when an event including at least one of a disallowed communication protocol sensing event (S110), a link release event (S111), and a link time elapse event (S112) of a network-linked external device is sensed, the power grid access security system may report the event to the management device in step S108.

Furthermore, in the above description, steps S101 to steps S112 may be more divided into additional steps, or may be combined as fewer steps, based on an implementation example of the present invention. Also, some steps may be omitted depending on the case, or the order of steps may be changed. Also, despite other omitted details, the descriptions of FIGS. 4 to 7 and the description of FIG. 8 may be mutually applied to each other.

An embodiment of the present invention described above may be implemented as a program (or an application) and may be stored in a medium, so as to be executed in connection with a computer which is hardware.

The program described above may include a code encoded as a computer language such as C, C++, JAVA, Ruby, or machine language readable by a processor (CPU) of a computer through a device interface of the computer, so that the computer reads the program and executes the methods implemented as the program. Such a code may include a functional code associated with a function defining functions needed for executing the methods, and moreover, may include an execution procedure-related control code needed for executing the functions by using the processor of the computer on the basis of a predetermined procedure. Also, the code may further include additional information, needed for executing the functions by using the processor of the computer, or a memory reference-related code corresponding to a location (an address) of an internal or external memory of the computer, which is to be referred to by a media. Also, when the processor needs communication with a remote computer or server so as to execute the functions, the code may further include a communication-related code corresponding to a communication scheme needed for communication with the remote computer or server and information or a media to be transmitted or received in performing communication, by using a communication module of the computer.

The stored medium may denote a device-readable medium semi-permanently storing data, instead of a medium storing data for a short moment like a register, a cache, and a memory. In detail, examples of the stored medium may include read only memory (ROM), random access memory (RAM), CD-ROM, a magnetic tape, floppy disk, and an optical data storage device, but are not limited thereto. That is, the program may be stored in various recording mediums of various servers accessible by the computer or various recording mediums of the computer of a user. Also, the medium may be distributed to computer systems connected to one another over a network and may store a code readable by a computer in a distributed scheme.

The foregoing description of the present invention is for illustrative purposes, those with ordinary skill in the technical field of the present invention pertains in other specific forms without changing the technical idea or essential features of the present invention that may be modified to be able to understand. Therefore, the embodiments described above, exemplary in all respects and must understand that it is not limited. For example, each component may be distributed and carried out has been described as a monolithic and describes the components that are to be equally distributed in combined form, may be carried out.

An embodiment of the present invention may provide safety and security in response to various cyber security problems occurring in the industrial network of the related art. The industrial network uses network protocol widely known, and due to this, an authorized user may attempt a disallowed network link by using various methods. This may cause an abnormal operation and a communication error in an OT device and user equipment and may be internationally recognized as a cyber security problem.

An embodiment of the present invention may effectively respond to the problem, and thus, may limit a network link and may enhance safety. First, an embodiment of the present invention may effectively limit a network link by adjusting a communication speed, a time of a communication port, and identification of a linked device, and thus, may prevent a disallowed network link and may increase the safety of a system.

Moreover, an embodiment of the present invention may provide a function of physically disconnect a link of a linked communication port. Therefore, an embodiment of the present invention may prevent a disallowed physical network access, and thus, may maintain the integrity of a system and may protect a safe environment against a potential threat.

Moreover, an embodiment of the present invention may limit a link time and protocol in a link-allowed device or user equipment. Accordingly, Moreover, an embodiment of the present invention may assign an appropriate authority to an unauthorized user and may prevent an undesired link, thereby securing safety and security.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A power grid access security system for intermittent communication ports, the power grid access security system comprising:
a link manager configured to manage and monitor a link of a communication port;
a power source configured to supply needed for a function operation of the communication port; and
a multi-interface configured to integrate and provide an interface for a network link and a security service,
wherein the link manager checks whether a network link of an external device is established, based on link setting information, and when a condition for the network link is not satisfied, removes data received from the external device, based on the link setting information.

2. The power grid access security system of claim 1, wherein the multi-interface obtains information of the external device including at least one of identification information, an access allowance time, a link method, whether encryption is used or not, and an encryption key for the external device, and
the link manager changes the link setting information, based on the information of the external device.

3. The power grid access security system of claim 2, wherein, when the link setting information is satisfied, the link manager allows the network link of the external device and when an event including at least one of a disallowed communication protocol sensing event, a link release event, and a link time elapse event of the network-linked external device is sensed, the link manager reports the event to the management device.

4. The power grid access security system of claim 3, further comprising an encryption unit configured to perform packet encryption and decryption on data transmitted or received to or from the network-linked external device.

5. The power grid access security system of claim 1, wherein the power grid access security system is implemented as a module type which is inserted into a communication port of network relay equipment.

6. The power grid access security system of claim 1, wherein the power grid access security system is implemented by printed circuit board (PCB) units of network relay equipment, or is implemented to be embedded in a network relay chipset as a system on chip (SoC) or system on package (SoP) type.

7. A power grid access security method for intermittent communication ports, performed by a power grid access security system for intermittent communication ports, the power grid access security method comprising:
as power is applied, maintaining a network link disconnection state;
as a configuration of link setting information for the network link is completed, operating in an interface standby state;
as an attempt to establish a network link of an external device is sensed, determining whether to allow a network link, based on the link setting information; and
when the link setting information is not satisfied, removing data received from the external device.

8. The power grid access security method of claim 5, wherein the operating in the interface standby state comprises:
obtaining information of the external device including at least one of identification information, an access allowance time, a link method, whether encryption is used or not, and an encryption key for the external device; and
changing the link setting information, based on the information of the external device.

9. The power grid access security method of claim 6, further comprising:
when the link setting information is satisfied, allowing the network link of the external device; and
when an event including at least one of a disallowed communication protocol sensing event, a link release event, and a link time elapse event of the network-linked external device is sensed, reporting the event to a management device.

10. The power grid access security method of claim 9, further comprising performing packet encryption and decryption on data transmitted or received to or from the network-linked external device.
